(19) United States
(12) Patent Application Publication
(10) Pub. No.: US 2005/0105387 A1
(43) Pub. Date: May 19, 2005

(54) Drink bottle with integrated mixing blades

(76) Inventor: Ali Nikkhah, Mission Viejo, CA (US)

Correspondence Address: SYLMARK, INC., 4929 WILSHIRE BLVD, SUITE 500, LOS ANGELES, CA, 90010, US

(21) Appl. No.: 10/894,858

(22) Filed: Jul. 20, 2004

Related U.S. Application Data
(60) Provisional application No. 60/490,124, filed on Jul. 25, 2003.

(51) Int. Cl. A47J 43/046

(52) U.S. Cl. 366/205; 220/714; 220/717; 366/314

(57) ABSTRACT

A sports bottle blender is disclosed for use with a mixing apparatus to blend mixed drinks. The sports bottle has a top with a closable opening therein such as a spout. A blade assembly is positioned at the bottom of the sports bottle extending into the sports bottle cavity. When the sports bottle is positioned on a mixing apparatus, such as a blender, the blade assembly operatively engages the blender such that operation of the blender causes the blade assembly to rotate. The rotation of the blade assembly mixes the ingredients in the sports bottle. The lower portion of the sports bottle is preferably detachable from the upper portion to provide easy access to the blade assembly for cleaning.

### RELATED APPLICATIONS

The present application claims priority from U.S. Provisional Application No. 60/490,124, entitled “DRINK BOTTLE WITH INTEGRATED MIXING BLADES,” filed on Jul. 25, 2003.

### FIELD OF INVENTION

The present invention relates generally to a beverage container and more particularly to a beverage container having integrated mixing blades adapted for use with a blender apparatus.

### BACKGROUND OF THE INVENTION

It is generally known to integrate fixed mixing blades inside a beverage container. For example, U.S. Pat. No. 2,965,274 to Brillis shows stationary mixing blades mounted within coffee cup. It is also known to use magnetic forces to rotate a metal rod placed loosely within a mixing container, typically for mixing chemicals. Examples of such mixers are disclosed in U.S. Pat. No. 2,466,468 to Neal and U.S. Pat. No. 3,245,665 to Steel.

The prior art also includes pitchers and cups with stirrers mounted inside the containers and actuated by self-contained motors, typically located at the bottom of the container. See, for example, U.S. Pat. No. 4,435,084 to Calhoun for stirring coffee and U.S. Pat. No. 5,425,579 to Sampson for stirring the contents of a pitcher. The patent to Calhoun also teaches a cup having a blade that can be manually actuated by inserting one's finger into an opening in a disk located underneath the cup and rotating the disk. The disk is connected by a shaft to the mixing blades, which causes the mixing blades to rotate when the disk is rotated.

U.S. Pat. Nos. 5,692,830 and 5,885,431, both to Costanzo, are directed to similar mixing devices comprising a tumbler-type container with a whisk rotatably mounted inside a container. The tumbler-type container is placed on a motor housing unit that is then placed on a tray, which provides electrical power to the motor housing unit. The motor disposed in the motor housing unit is actuated by a pressure switch when the container is placed on the motor housing unit. However, this design requires a special device for actuating the mixing blades. In addition, both patents teach the placement of the container in a recess on the top surface of the motor housing unit so the container will actuate the motor using a pressure switch.

### SUMMARY OF THE PREFERRED EMBODIMENT

A sports bottle blender is disclosed for use with a mixing apparatus to blend mixed drinks. The sports bottle has a top with a closable opening therein such as a spout. A blade assembly is positioned at the bottom of the sports bottle extending into the sports bottle cavity. When the sports bottle is positioned on a mixing apparatus, such as a blender, the blade assembly operatively engages the blender such that operation of the blender causes the blade assembly to rotate. The rotation of the blade assembly mixes the ingredients in the sports bottle. The lower portion of the sports bottle is preferably detachable from the upper portion to provide easy access to the blade assembly for cleaning.

### BRIEF DESCRIPTION OF DRAWINGS

FIG. 1 is a partial cut-away view of a preferred embodiment of the drinking bottle of the present;

FIG. 2 is a cross-sectional view taken along line 2′-2′ of FIG. 1; and

FIG. 3 is a schematic diagram of a drinking bottle in accordance with an embodiment of the present invention as placed on a blender apparatus.

Like numbers refer to like elements throughout the specification.

### DETAILED DESCRIPTION OF PREFERRED EMBODIMENTS

The present invention now will be described more fully hereinafter with reference to the accompanying drawings, in which some, but not all embodiments of the invention are shown. Indeed, the invention may be embodied in many different forms and should not be construed as limited to the embodiments set forth herein.

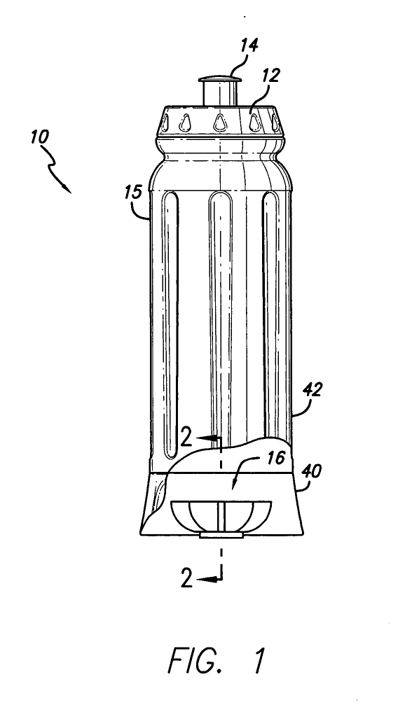

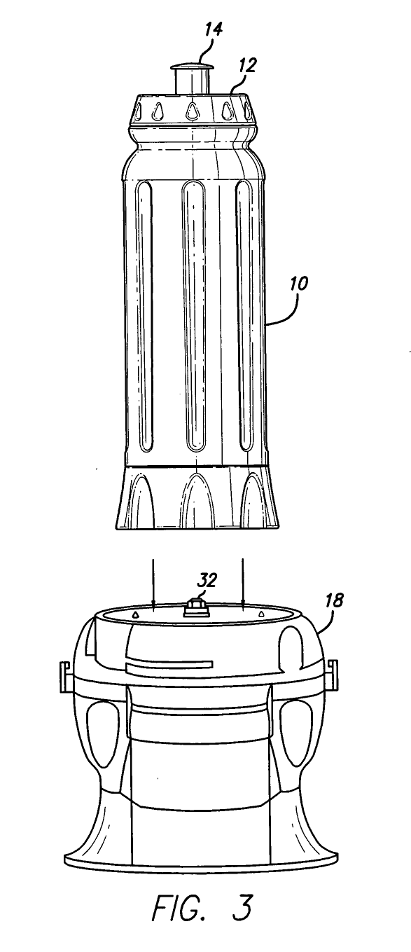

With reference to FIGS. 1 through 3, the present invention is a rigid or semi-rigid plastic drink bottle 10, also known as a sports bottle, for use in drinking water, juice, shakes or the like. In a preferred embodiment of the invention, the drink bottle 10 includes a lid 12 having a nozzle 14 through which the contents of the drink bottle can be ejected by squeezing the bottle. In another preferred embodiment, the nozzle 14 can be replaced with a straw inserted through an aperture in the lid 12. The lid can be integrally attached to the drink bottle body 15 or can be removably attached thereto. In a preferred embodiment of the invention, the drink bottle is composed of high-density polyethylene plastic material.

The mixing blade assembly 16 is preferably incorporated into the interior cavity of the drink bottle. In the illustrated embodiment, the blade assembly 16 is rotatably mounted to the bottom of the bottle with a substantially watertight seal, such as utilized with blender containers or other similar devices. However, the blade assembly 16 can be located on a side or top of the drink bottle if desired. When rotated, the mixing blade assembly 16 is designed to mix the contents of the drink bottle 10, much like a blender.

In a preferred embodiment of the invention, a household kitchen appliance, such as a blender or food processor 18, actuates the mixing blade assembly 16 of the drink bottle 10. With certain appliances, an adapter may be required to hold the drink bottle 10 in place during mixing. For example, the adapter may be securely mounted to the appliance 18 and configured to create a receptacle for receiving and holding the drink bottle 10 while being actuated by the appliance. In certain configurations, the drink bottle 10 may include outward protrusions designed to be urged against the adapter or a portion of the appliance to prevent rotational movement of the bottle when the appliance is actuated. Such protrusions may take the form of a notched pattern (or any other suitable pattern), disposed on the bottom of the drink bottle, similar to the bottom of a typical blender container.

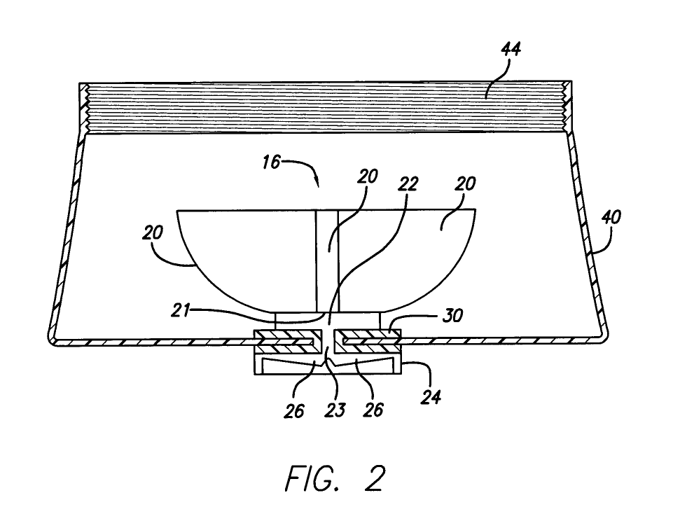

In a preferred embodiment of the invention, the blade assembly 16 is adapted to operatively engage the spindle of the motor of a known blender apparatus. With reference to FIG. 2, the blade assembly 16 preferably comprises shaft 22 having a first end 21 and a second end 23. A plurality of blades 20 are attached at the first end 21 of shaft 22. A cap 24 is attached at the second end 23 of shaft 22. The cap 24 is dimensioned and shaped to receive the spindle of the blender apparatus. In a preferred embodiment of the invention, the cap 24 includes fins 26 with a recess 27 for engaging the spindle.

The shaft 22 of the mixing blade assembly extends through an aperture in the bottom of the drink bottle, which is sealed by a rubber gasket that surrounds the shaft 22. The blade assembly is preferably made of a lightweight material such as plastic. The size and configuration of the individual blades 20 may be based, at least in part, on the size and shape of the drink bottle. In addition, the blade assembly may have any suitable number of individual blades 20.

The blade assembly 16 is preferably configured for use in mixing powdered drinks and shakes. In this regard, once the constituents of the powdered drink or shake are placed within the drink bottle 10, the drink bottle is placed on the appliance 18 so that the blade assembly 16 couples to the spindle 32. When the blade assembly 16 engages spindle 32, the actuation of the appliance 18 causes the rotation of the blade assembly 16. Once the appliance is turned off, then the drink bottle 10 can be removed from the mixing appliance and the contents immediately consumed without transfer to another container.

Advantageously, a drink mixed within the drink bottle 10 can be mixed within and consumed from a single container. This reduces the number of items that must be cleaned in association with the preparation of a powder drink or shake, which not only reduces the time and effort required to prepare the drink and then clean up, it also conserves energy because fewer dishes need to be washed.

To facilitate the cleaning of the drink bottle after the contents have been drunk, in a preferred embodiment of the invention, the body 15 of the drink bottle 10 comprises a lower portion 40 that is detachable from the upper portion 42. The lower portion 40 preferably houses the mixing blade assembly 16. As shown in FIG. 2, the upper edge 44 of the lower portion is externally threaded. The external threads correspond to and engage internal threads on the upper portion 42 of the drink bottle body 15. The upper portion 42 and lower portion 40 sealingly mate so that liquid does not seep out during the blending process. When the blending process is finished, the drink bottle 10 is removed from the appliance 18 and the contents of the drink bottle 10 are consumed directly from the bottle 10. To clean the bottle 10, the lower portion 40 is rotated with respect to the upper portion 42, to unthread and disengage the lower portion 40 from the upper portion 42. Separating the lower portion 40 from the upper portion 42 provides easier access to the mixing blade assembly 16 and thus. enables the user to better clean the blade assembly 16. Although the lower portion 40 is described as threadingly engaged with the upper portion 42, it is envisioned that the lower portion 40 can engage the upper portion 42 using any known interlocking device.

A preferred method of blending and consuming a mixed a beverage in accordance with the present invention is now described. To blend a desired mixed drink, the lower portion 40 of the drink bottle body 10 is removed. The drink bottle 10 is turned upside down such that the nozzle 14 is positioned at the bottom, closest to the floor. The drink ingredients are placed into the drink bottle cavity. The nozzle should be closed to prevent the beverage ingredients from leaking out.

After the drink ingredients have been placed in the drink bottle cavity, the lower portion 40 is refastened to the upper portion 42. The drink bottle 10 is then turned right side up such that the nozzle 14 is positioned at the top of the drink bottle 10 and the drink bottle is positioned on the appliance 18 for mixing. The mixing blade assembly 16 engages the spindle 32 of the appliance 18 and the actuation of the appliance 18 causes the mixing blade assembly to blend the ingredients in the drink bottle together to form a mixed drink.

After the blended drink has been consumed, to clean the drink bottle, the drink bottle is turned upside down to prevent any remaining contents from spilling out during the removal of the lower portion 40. The lower portion 40 is then unfastened from the upper portion 42 of the drink bottle 10. The lower portion 40 and upper portion 42 can be cleaned separately. By separating the lower portion 40 from the upper portion 42, direct access is provided to the mixing blade assembly 16, which is typically the component that needs the most attention during cleaning. If the lower portion 40 is not separable from the upper portion 42, the drink bottle would need a removable top (not shown). During the cleaning process, the user would have to reach the mixing blade assembly 16 by removing the top and accessing the blade assembly 16 through the opening at the top of the drink bottle 10. Because the blade assembly 16 is positioned at the opposite end, the user would probably need a long-handled brush or other tool to effectively clean the blade assembly 16. By providing the removable lower portion 40, the present invention enables the user to clean the blade assembly 16 without the need for a long-handled brush or other tool.

When the upper portion 42 of the drink bottle 10 is cleaned, the nozzle 14 on the lid 12 can be opened to allow water to run through the nozzle 14 and thus, clean the nozzle.

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A sports bottle for use with a mixing apparatus to blend mixed drinks, the sports bottle comprising:
a bottle body having a top and a bottom and defining a cavity therein, the top having a closable opening therein, the opening adapted to allow for the passage of a mixed drink therethrough; and
a blade assembly at the bottom end of the bottle body, the blade assembly extending into the cavity.

2. The sports bottle of claim 1 further comprising a shaft having a first end and a second end, the first end of the shaft operatively connected to the blade assembly and the second end of the shaft configured to be connected to the mixing apparatus.

3. The sports bottle of claim 1 wherein the shaft extends through an aperture at the bottom of the bottle body.

4. The sports bottle of claim 2 wherein the shaft second end of the shaft comprises fins.

5. The sports bottle of claim 1 wherein the bottle body comprises an upper portion and a lower portion, wherein in a use configuration, the upper portion sealingly engages the lower portion, and in a cleaning configuration, the upper portion is removable from the lower portion, and wherein the blade assembly is located in the lower portion.

6. The sports bottle of claim 5 wherein the upper portion threadingly engages the lower portion.

7. A sports bottle for use with a mixing apparatus to blend mixed drinks, the sports bottle comprising:
a bottle body having a top and a bottom and defining a cavity therein, the top having a closable opening therein, the opening adapted to allow for the passage of a mixed drink therethrough, the bottle body having an upper portion and a lower portion,
a blade assembly located in the lower portion of the bottle body, the blade assembly extending into the cavity;
a use configuration, wherein in the use configuration the upper portion sealingly engages the lower portion; and
a cleaning configuration, wherein in the cleaning configuration the upper portion is removable from the lower portion.

8. The sports bottle of claim 7 further comprising a shaft having a first end and a second end, the first end of the shaft operatively connected to the blade assembly and the second end of the shaft configured to be connected to the mixing apparatus.

9. The sports bottle of claim 8 wherein the shaft extends through an aperture at the bottom of the bottle body.

10. The sports bottle of claim 8 wherein the shaft second end of the shaft comprises fins.

11. A method of making a mixed drink of at least two ingredients using a mixing apparatus, comprising the steps of:
providing a sports bottle comprising a bottle body having a top and a bottom and defining a cavity therein, the top having a closable opening therein, the opening adapted to allow for the passage of a mixed drink therethrough, the bottle body having an upper portion removably attached to a lower portion, and a blade assembly located in the lower portion of the bottle body, the blade assembly extending into the cavity;
separating the lower portion from the upper portion;
turning the sports bottle upside down;
closing the opening in the top;
placing the at least two ingredients into the cavity of the bottle body;
fastening the upper portion to the lower portion;
positioning the bottle body on the mixing apparatus such that the blade assembly is operatively connected to the mixing apparatus; and
activating the mixing apparatus to activate the blade assembly.

12. The method of claim 11 wherein the lower portion is threadingly fastened to the upper portion.

13. The method of claim 11 further comprising a shaft having a first end and a second end, the first end of the shaft operatively connected to the blade assembly and the second end of the shaft configured to be connected to the mixing apparatus.

14. The sports bottle of claim 13 wherein the shaft extends through an aperture at the bottom of the bottle body.

15. The sports bottle of claim 13 wherein the shaft second end of the shaft comprises fins.
